(19) United States
(12) Patent Application Publication
(10) Pub. No.: US 2008/0212487 A1
(43) Pub. Date: Sep. 4, 2008

(54) Method and Apparatus for Monitoring TCP Sessions in a Mobile Data Network and Developing Corresponding Performance Metrics

(76) Inventors: Leonardo Silvestri, Somonauk, IL (US); Tengywe E. Hong, Naperville, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/935,190

(22) Filed: Nov. 5, 2007

Related U.S. Application Data
(60) Provisional application No. 60/856,947, filed on Nov. 6, 2006.

(51) Int. Cl. G06F 11/00

(52) U.S. Cl. 370/253

(57) ABSTRACT

These teachings provide for monitoring TCP sessions in a mobile data network and developing corresponding performance metrics to aid in monitoring session quality. The performance metrics can be used to form a corresponding indicator of aggregated session quality that can be used to facilitate the monitoring of TCP session quality.

### CROSS-REFERENCE TO RELATED APPLICATION

This application claims the benefit of U.S. Provisional application Ser. No. 60/856,947, filed Nov. 6, 2006, which is incorporated by reference in its entirety herein.

### TECHNICAL FIELD

This invention relates generally to Transmission Control Protocol (TCP)-based communications that occur in a mobile data network.

### BACKGROUND

It is generally known that there exists in the art conventional algorithms that monitor TCP session quality in a data network. Typically, these conventional algorithms can track TCP packets and calculate TCP packet loss, out-of-order, and retransmission ratios separately and report the corresponding ratios. For various reasons, these conventional algorithms tend to work best for a wireline network.

Such approaches provide a useful service in at least some application settings. There are times, however, when existing practices in this regard are not wholly satisfactory. The problem with using the conventional algorithms on a mobile data network is that mobile data networks behave differently from the wireline networks for which the conventional algorithms were designed.

A mobile data network generally includes a radio network as at least one of its transmission paths. The nature and various characteristics of such radio networks are such that they can make out-of-order delivery of packets and latency on the mobile network much more pronounced during a TCP session as compared to a typical wireline network. These packet delivery problems, although not actually resultant from TCP congestion, appear exactly like TCP congestion to the sender. This circumstance, in turn, impairs accuracy of conventional session quality measurement algorithms when applying such algorithms in a mobile data network.

### BRIEF DESCRIPTION OF THE DRAWINGS

The above needs are at least partially met through provision of the method and apparatus for monitoring TCP sessions in a mobile data network and developing corresponding performance metrics described in the following detailed description, particularly when studied in conjunction with the drawings, wherein:

FIG. 1 comprises a schematic view as configured pursuant to the various teachings of this invention;

FIG. 2 comprises a flow diagram as configured pursuant to the various teachings of this invention;

FIG. 3 comprises a block diagram as configured pursuant to the various teachings of this invention; and

FIG. 4 comprises a flow diagram as configured pursuant to the various teachings of this invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, these teachings provide for monitoring TCP sessions in a mobile data network and developing corresponding performance metrics to aid in monitoring session quality. The performance metrics can be used to form a corresponding indicator of aggregated session quality that can be used to facilitate the monitoring of TCP session quality.

By one approach, these teachings will also optionally facilitate the delivery of component quality performance indicators through use of performance metrics that can comprise, at least in part, metrics regarding TCP retransmission packets and duplicate acknowledgment packets. By another approach, these teachings will use the performance metrics and the corresponding indicator of aggregated session quality to form various pairs of ratios of performance metrics as well as congestion ratios to determine a TCP quality rating.

So configured, those skilled in the art will appreciate that these teachings will provide a new TCP session quality indication algorithm for mobile data networks that will solve the problems associated with using conventional algorithms in such an application setting. Furthermore, those skilled in the art will appreciate that these teachings will provide a manner to track TCP packets, calculate TCP retransmissions, TCP duplicate acknowledgements and TCP congestion ratios separately and to report the corresponding ratios in order to accurately produce a rating for the TCP session quality on a mobile data network.

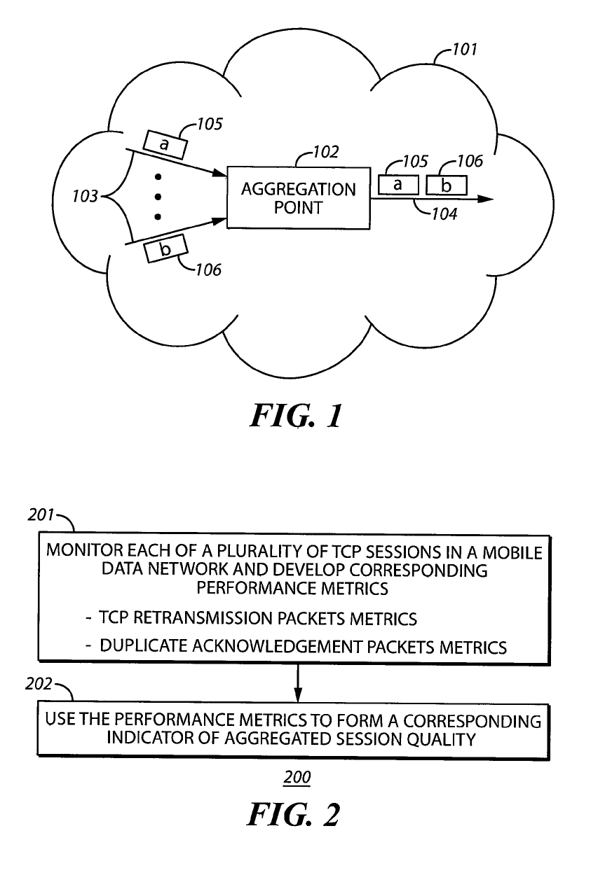

These and other benefits may become clearer upon making a thorough review and study of the following detailed description. Referring now to the drawings, and in particular to FIG. 1, these teachings pertain to a description of how a Transmission Control Protocol (TCP) session quality indication algorithm can interact with a mobile data network 101. A given network 101 can be comprised of one or more aggregation points 102. As used herein, the expression aggregation point will be understood to refer to a location within a given network where a plurality of data streams are aggregated into a fewer number of streams, typically one. In this illustrative example, an aggregation Point 102 uses a plurality of different and distinct service delivery paths 103 to receive, as shown, a first TCP traffic element A 105 and a second TCP traffic element B 106. The aggregation point 102 in turn aggregates these traffic elements from different service delivery paths to provide an output comprising an aggregated service delivery path 104 bearing both of the aforementioned TCP traffic elements A 105 and B 106. By one approach, the teachings described herein are facilitated through interaction with such an aggregation point 102.

By one approach, and referring now to the flow diagram of FIG. 2, illustrative process 200 shows the monitoring of various performance metrics within a mobile data network. Various mobile data networks are known in the art and others are likely to be developed going forward. These teachings are generally applicable with most if not all such technologies. For the sake of illustration and not by way of limitation, the remainder of this description will presume that the mobile data network comprises a 3GPP-based mobile data network as is known in the art.

The performance metrics can comprise TCP retransmission packets and Duplicate acknowledgement packets. After the performance metrics are developed, process 202 shows the use of performance metrics to form a corresponding indicator of aggregated session quality.

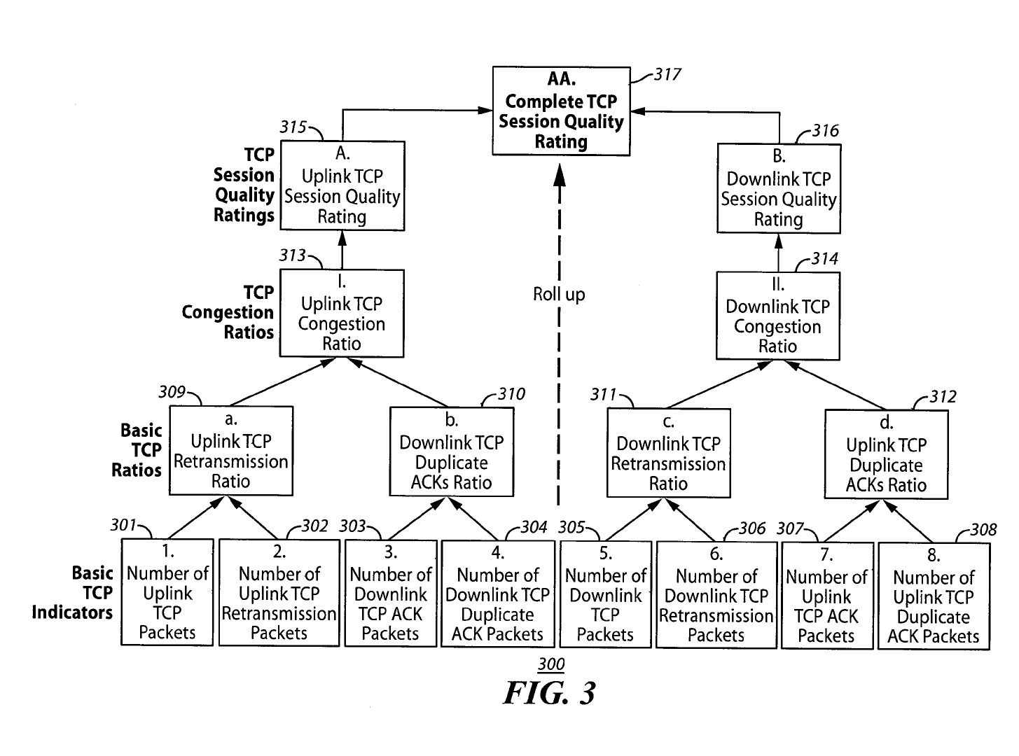

By one approach, and referring now to FIG. 3 an illustrative TCP session quality indication process can be represented by a logical flow diagram 300. By one approach, the Basic TCP Indicators comprise performance metrics that are represented as different forms of uplink and downlink packets. As used herein, the term uplink is used to refer to packets traveling from the mobile handset via the mobile data network to the server and the term downlink is used to refer to packets traveling from the server via the mobile data network to the mobile handset.

The performance metrics can be comprised of at least one or more of the Number of Uplink TCP Packets 301, the Number of Uplink TCP Retransmission Packets 302, the Number of Downlink TCP Acknowledgment (ACK) Packets 303, the Number of Downlink TCP Duplication ACK Packets 304, the Number of Downlink TCP Packets 305, the Number of Downlink TCP Retransmission Packets 306, the Number of Uplink TCP ACK Packets 307, and the Number of Uplink TCP Duplicate ACK Packets 308. These performance metrics are defined as listed below:

Number of Uplink TCP packets 301 refers to the count of uplink TCP packets within a given measuring interval.

Number of Uplink TCP Retransmission packets 302 refers to the count of uplink TCP retransmission packets within a given measuring interval

Number of Downlink TCP ACK packets 303 refers to the count of downlink TCP ACK packets within a given measuring interval.

Number of Downlink TCP Duplicate ACK packets 304 refers to the count of downlink TCP duplicate ACK packets within a given measuring interval.

Number of Downlink TCP packets 305 refers to the count of downlink TCP packets within a given measuring interval.

Number of Downlink TCP Retransmission packets 306 refers to the count of downlink TCP retransmission packets within a given measuring interval.

Number of Uplink TCP ACK packets 307 refers to the count of uplink TCP ACK packets within a given measuring interval.

Number of Uplink TCP Duplicate ACK packets 308 refers to the count of uplink TCP duplicate ACK within a given measuring interval.

The above performance metrics are used by the TCP session quality indication process to calculate a variety of Basic TCP Ratios. In this illustrative example, these Basic TCP Ratios are comprised of an Uplink TCP Retransmission Ratio 309, a Downlink TCP Duplicate ACKs Ratio 310, a Downlink TCP Retransmission Ratio 311, and an Uplink TCP Duplicate ACK Ratio 312. For the purposes of this example, these ratios will be understood as follows:

The Uplink TCP Retransmission Ratio 309 can be the ratio of the Number of Uplink TCP Retransmission packets 302 versus the Number of Uplink TCP packets 301.

The Downlink TCP Duplicate ACKs Ratio 310 can be the ratio of the Number of Downlink TCP Duplicate ACK packets 304 versus the Number of Downlink TCP ACK packets 303.

The Downlink TCP Retransmission Ratio 311 can be the ratio of the Number of Downlink TCP Retransmission packet 306 versus the Number of Downlink TCP packets 305.

The Uplink TCP Duplicate ACKs Ratio 312 can be the ratio of the Number of Uplink TCP Duplicate ACKs packets 308 versus the Number of Uplink TCP ACK packets 307.

Exemplary formulas for the above ratios can be viewed in Table 1 (reproduced below).

The Basic TCP Ratios are used to calculate TCP Congestion Ratios which can include the Uplink TCP Congestion Ratio 313 and the Downlink TCP Congestion Ratio 314.

The Uplink TCP Congestion Ratio 313 can be calculated as an average of Uplink TCP Retransmission Ration 309 and Downlink TCP Duplicate ACKS Ratio 310 within a measuring interval. The Downlink TCP Congestion Ratio 314 can be calculated as an average of Downlink TCP Retransmission Ration 311 and Uplink TCP Duplicate ACKS Ratio 312 within a measuring interval. These formulas for the above ratios can also be viewed in Table 1 (reproduced below).

Still referring to FIG. 3, the TCP Congestion Ratios can be rated in order to obtain TCP Session Quality Ratings. Computation of both an Uplink TCP Session Quality Rating 315 and a Downlink TCP Session Quality Rating 316 from the Uplink TCP Congestion Ratio 313 and the Downlink TCP Congestion Ratio 314, respectively, can be based on a direct relationship of TCP packet error rate and the TCP retransmission ratio using well known algorithms (such as, for example, the approaches set forth in a paper entitled Performance Evaluation of TCP Congestion Control Algorithms Over UMTS as written by Boggia et al. which is included as an appendix with this specification).

A Complete TCP Session Quality Rating 317 can then be computed from the Uplink TCP Session Quality Rating 315 and the Downlink TCP Session Quality Rating 316. The Complete TCP Session Quality Rating 317 is computed by taking the average rating between the Uplink TCP Session Quality Rating 315 and the Downlink TCP Session Quality Rating 316. This calculation and rating is shown below in Table 1 and the rating provides a depiction of the lower layer indicators.

TABLE 1

| Indicators | Roll-up Formula | | | | | |
|---|---|---|---|---|---|---|
| Uplink TCPRetransmissionRatio | $= \frac{No . of Uplink TCP Retransmission Packet 302}{No . of Uplink TCP Packet 301}$ | | | | | |
| Downlink TCPDuplicate ACKRatio | $= \frac{No . of Downlink TCP Duplicate ACK Packet 304}{No . of Downlink TCP ACK Packet 303}$ | | | | | |
| Downlink TCPRetransmissionRatio | $= \frac{No . of Downlink TCP Retransmission Packet 306}{No . of Downlink TCP Packet 305}$ | | | | | |
| Uplink TCPDuplicate ACKRatio | $= \frac{No . of Uplink TCP Duplicate ACK Packet 308}{No . of Uplink TCP ACK Packet 307}$ | | | | | |
| Uplink TCPCongestion Ratio | $= \frac{Uplink TCP Retransmission Ratio 309 + Downlink TCP Duplicate ACKS Ratio 310}{2}$ | | | | | |
| Downline TCPCongestion Ratio | $= \frac{Downlink TCP Retransmission Ratio 311 + Uplink TCP Duplicate ACKS Ratio 312}{2}$ | | | | | |
| Uplink TCP | | | | | | |
| Session Quality | Uplink/Downlink | | | | | |
| Rating | TCP | | 0.6% < | 1.2% < | 3.5% < | |
| Downlink TCP | Congestion | Ratio <= | Ratio <= | Ratio <= | Ratio <= | Ratio > |
| Session Quality | Ratio* | 0.6% | 1.2% | 3.5% | 10% | 10% |
| Rating | Rating | Excellent | Very Good | Good | Fair | Poor |
| | Numerical | 5 | 4 | 3 | 2 | 1 |
| | Rating | | | | | |
| Complete TCPSession Quality | $= \frac{Uplink TCP Session Quality Rating 315 + Uplink TCP Session Quality Rating 316}{2}$ | | | | | |
| Rating | Rating | Excellent | Very Good | Good | Fair | Poor |
| | Numerical | 5 | 4 | 3 | 2 | 1 |
| | Rating | | | | | |

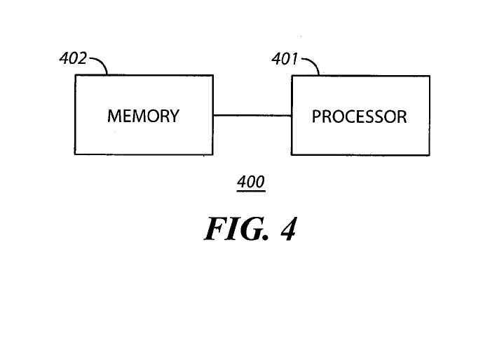

By another approach, and referring now to FIG. 4, the TCP session quality indication process can be generally carried out by a processor 401 and a memory 402. The processor 401 itself can comprise a fixed-purpose hardwired platform if desired, or can comprise a partially or wholly programmable platform. All of these architectural options are well known in the art and need no further elaboration here.

The processor 401 can be operably connected to the memory 402 and configured to carry out some or all of the steps, actions, and/or functionality as are described herein as may be desired. This can comprise, for example, monitoring a plurality of TCP sessions and developing corresponding performance metrics within a measured interval of time and using the performance metrics to form a corresponding indicator of session quality. This could also comprise, as a further example, identifying a service delivery component that is at least partially responsible for dropping the active data session.

By one approach, and still referring to FIG. 4, the processor 401 can be configured to develop corresponding performance metrics that can comprise at least one of: a number of uplink TCP packets, a number of uplink TCP retransmission packets, a number of downlink acknowledgement packets, a number of downlink duplicate acknowledgement packets, a number of downlink TCP packets, a number of downlink TCP retransmission packets, a number of uplink TCP acknowledgement packets or a number of uplink duplicate acknowledgement packets.

By another approach, and still referring to FIG. 4, the processor 401 can be configured to develop performance metrics that can be used to compute at least one of the following: a corresponding indicator of aggregated session quality, congestion ratios, congestion ratios that can determine a TCP session quality rating, and/or a corresponding indicator of aggregated service delivery component.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one of many examples, these teachings will provide a new TCP session quality indication process that uses a variety of performance metrics in order to compute the complete TCP session quality rating on a mobile data network. Those skilled in the art will appreciate that these teachings provide a method that efficiently, economically, and reliably yields TCP Basic Indicators and performance metrics separately and that uses the corresponding ratios in order to produce a rating for the TCP session quality on a mobile data network.

We claim:

1. A method comprising:
monitoring each of a plurality of transmission control protocol (TCP) sessions in a mobile data network and developing corresponding performance metrics, wherein the performance metrics comprise, at least in part, metrics regarding TCP retransmission packets and duplicate acknowledgement packets;
using the performance metrics to form a corresponding indicator of aggregated session quality, whereas, TCP traffic being substantially the majority of traffic in a mobile network, the aggregation of the session quality performance indicators by service delivery component affords statistically significant service delivery component quality performance indicators.

2. The method of claim 1 wherein monitoring each of a plurality of transmission control protocol (TCP) sessions and developing corresponding performance metrics, wherein the performance metrics comprise, at least in part, metrics regarding TCP retransmission and duplicate acknowledgement packets further comprises developing performance metrics regarding downlink TCP retransmission and duplicate acknowledgement packets.

3. The method of claim 1 wherein monitoring each of a plurality of transmission control protocol (TCP) sessions and developing corresponding performance metrics, wherein the performance metrics comprise, at least in part, metrics regarding TCP retransmission and duplicate acknowledgement packets further comprises developing performance metrics regarding uplink retransmission and TCP duplicate acknowledgement packets.

4. The method of claim 1 wherein monitoring each of a plurality of transmission control protocol (TCP) sessions and developing corresponding performance metrics comprises monitoring each of a plurality of transmission control protocol (TCP) sessions over a predetermined period of time and developing corresponding performance metrics for that predetermined period of time.

5. The method of claim 1 wherein monitoring each of a plurality of transmission control protocol (TCP) sessions and developing corresponding performance metrics further comprises monitoring each of a plurality of transmission control protocol (TCP) sessions and developing corresponding performance metrics, wherein the performance metrics further comprise, at least in part, at least one of:
number of uplink TCP packets;
number of uplink TCP retransmission packets;
number of downlink TCP acknowledgement packets;
number of downlink TCP duplicate acknowledgement packets;
number of downlink TCP packets;
number of downlink TCP retransmission packets;
number of uplink TCP acknowledgement packets;
number of uplink TCP duplicate acknowledgement packets.

6. The method of claim 5 wherein monitoring each of a plurality of transmission control protocol (TCP) sessions and developing corresponding performance metrics further comprises monitoring each of a plurality of transmission control protocol (TCP) sessions and developing corresponding performance metrics that comprise each of:
number of uplink TCP packets;
number of uplink TCP retransmission packets;
number of downlink TCP acknowledgement packets;
number of downlink TCP duplicate acknowledgement packets;
number of downlink TCP packets;
number of downlink TCP retransmission packets;
number of uplink TCP acknowledgement packets;
number of uplink TCP duplicate acknowledgement packets.

7. The method of claim 1 wherein using the performance metrics to form a corresponding indicator of aggregated session quality comprises, at least in part, forming ratios of various pairs of the performance metrics.

8. The method of claim 7 wherein using the performance metrics to form a corresponding indicator of aggregated session quality further comprises, at least in part, forming congestion ratios of various pairs of the ratios of various pairs of the performance metrics.

9. The method of claim 8 wherein using the performance metrics to form a corresponding indicator of aggregated session quality comprises, at least in part, using the congestion ratios to determine a TCP session quality rating.

10. The method of claim 7 wherein using the performance metrics to form a corresponding indicator of aggregated service delivery component quality further comprises, at least in part, forming congestion ratios of various pairs of the ratios of various pairs of the performance metrics.

11. The method of claim 8 wherein using the performance metrics to form a corresponding indicator of aggregated service delivery component quality comprises, at least in part, using the congestion ratios to determine a service delivery component quality rating.

12. The method of claim 1 wherein using the performance metrics to form a corresponding indicator of aggregated service delivery component quality comprises, at least in part, forming ratios of various pairs of the performance metrics.

13. An apparatus comprising:
a memory;
a processor operably coupled to the memory and being configured and arranged to:
monitor each of a plurality of transmission control protocol (TCP) sessions and develop corresponding performance metrics, wherein the performance metrics comprise, at least in part, metrics regarding TCP duplicate acknowledgement packets;
use the performance metrics to form a corresponding indicator of aggregated session quality, whereas, TCP traffic being substantially the majority of traffic in a mobile network the aggregation of the session quality metrics by service delivery component affords statistically correct service delivery component quality metrics.

14. The apparatus of claim 13 wherein the performance metrics further comprise, at least in part, metrics regarding downlink TCP retransmission and duplicate acknowledgement packets.

15. The apparatus of claim 13 wherein the performance metrics further comprise, at least in part, metrics regarding uplink TCP retransmission and duplicate acknowledgement packets.

16. The apparatus of claim 13 wherein the processor is further configured and arranged to monitor each of a plurality of transmission control protocol (TCP) sessions and developing corresponding performance metrics by monitoring each of a plurality of transmission control protocol (TCP) sessions over a predetermined period of time and developing corresponding performance metrics for that predetermined period of time.

17. The apparatus of claim 13 wherein the processor is further configured and arranged to monitor each of a plurality of transmission control protocol (TCP) sessions and develop corresponding performance metrics by monitoring each of a plurality of transmission control protocol (TCP) sessions and developing corresponding performance metrics, wherein the performance metrics further comprise, at least in part, at least one of:
number of uplink TCP packets;
number of uplink TCP retransmission packets;
number of downlink TCP acknowledgement packets;
number of downlink TCP duplicate acknowledgement packets;
number of downlink TCP packets;
number of downlink TCP retransmission packets;
number of uplink TCP acknowledgement packets;
number of uplink TCP duplicate acknowledgement packets.

18. The apparatus of claim 15 wherein the processor is further configured and arranged to monitor each of a plurality of transmission control protocol (TCP) sessions and develop corresponding performance metrics by monitoring each of a plurality of transmission control protocol (TCP) sessions and developing corresponding performance metrics that comprise each of:
number of uplink TCP packets;
number of uplink TCP retransmission packets;
number of downlink TCP acknowledgement packets;
number of downlink TCP duplicate acknowledgement packets;
number of downlink TCP packets;
number of downlink TCP retransmission packets;
number of uplink TCP acknowledgement packets;
number of uplink TCP duplicate acknowledgement packets.

19. The apparatus of claim 15 wherein the processor is further configured and arranged to use the performance metrics to form a corresponding indicator of aggregated session quality by, at least in part, forming ratios of various pairs of the performance metrics.

20. The apparatus of claim 19 wherein the processor is further configured and arranged to use the performance metrics to form a corresponding indicator of aggregated session quality by, at least in part, forming congestion ratios of various pairs of the ratios of various pairs of the performance metrics.

21. The apparatus of claim 20 wherein the processor is further configured and arranged to use the performance metrics to form a corresponding indicator of aggregated session quality by, at least in part, using the congestion ratios to determine a TCP session quality rating.

22. The apparatus of claim 13 wherein the processor is further configured and arranged to use the performance metrics to form a corresponding indicator of aggregated service delivery component quality by, at least in part, forming ratios of various pairs of the performance metrics.

23. The apparatus of claim 19 wherein the processor is further configured and arranged to use the performance metrics to form a corresponding indicator of aggregated service delivery component quality by, at least in part, forming congestion ratios of various pairs of the ratios of various pairs of the performance metrics.

24. The apparatus of claim 20 wherein the processor is further configured and arranged to use the performance metrics to form a corresponding indicator of aggregated service delivery component quality by, at least in part, using the congestion ratios to determine a service delivery component quality rating.
